(19) United States
(12) Patent Application Publication
(10) Pub. No.: US 2026/0363947 A1
(43) Pub. Date: Nov. 19, 2026

(54) MASSAGE BELT

(71) Applicant: SKG Health Technologies Co., Ltd., Shenzhen (CN)

(72) Inventors: Heng Li, Shenzhen (CN); Jian Zhang, Shenzhen (CN); Jun-Ling Cao, Shenzhen (CN)

(21) Appl. No.: 19/421,649

(22) Filed: Dec. 16, 2025

(30) Foreign Application Priority Data
May 16, 2025 (CN) 202510638949.2

(51) Int. Cl. A61H 23/02

(52) U.S. Cl. CPC A61H 23/0263; A61H 2201/165

(57) ABSTRACT

A massage belt includes a belt body and a vibration assembly; the belt body is made of a flexible material, the vibration assembly comprises an eccentric weight and a motor drivingly connected to the eccentric weight. The vibration assembly is connected to the belt body and is configured to, when the eccentric weight rotates, generate a periodic vibration and transmit the vibration to the belt body, a vibration direction of the periodic vibration being perpendicular to a first direction. The belt body has a relatively large massage area; by driving the belt body through the vibration assembly to massage a target area, the massage area on the target area is increased. The belt body made of the flexible material can improve wearing comfort of the massage belt, and the flexible belt body can better fit the target area, thereby improving massage uniformity and massage effect of the massage belt.

### CROSS-REFERENCE TO RELATED APPLICATIONS

This application claims priority to Chinese Patent Application No. 202510638949.2, filed on May 16, 2025, the entire contents of which are incorporated herein by reference.

### FIELD

The disclosure relates to the technical field of massage apparatus, and in particular to a massage belt.

### BACKGROUND

With social development and improvement of living standards, people are paying increasing attention to their body shape and have a growing need for body management. Massage belts are therefore gaining popularity. A massage belt is a device that massages areas such as a user's abdomen or waist; it can relax muscles, relieve fatigue, and assist slimming.

In related art, the massage area of massage belts is limited and the massage effect is poor.

### SUMMARY

The disclosure provides a massage belt, including a belt body and a vibration assembly.

The belt body is made of a flexible material.

The vibration assembly includes a motor and an eccentric weight, the motor being drivingly connected to the eccentric weight.

The vibration assembly is connected to the belt body, the vibration assembly is configured to, when the eccentric weight rotates, generate a periodic vibration and transmit the vibration to the belt body, a vibration direction of the periodic vibration being perpendicular to a first direction.

### DESCRIPTION OF DRAWINGS

FIG. 1 is a schematic structural view of a massage belt in some embodiments.

FIG. 2 is an exploded structural view of the massage belt in some embodiments.

FIG. 3 is a first cross-sectional structural view of the massage belt in some embodiments.

FIG. 4 is a second cross-sectional structural view of the massage belt in some embodiments.

FIG. 5 is a third cross-sectional structural view of the massage belt in some embodiments.

FIG. 6 is an exploded structural view of a vibration assembly and a second mounting seat in some embodiments.

FIG. 7 is a structural view of the vibration assembly mounted on the second mounting seat in some embodiments.

FIG. 8 is a structural view of a second body and a first mounting seat in some embodiments.

FIG. 9 is a structural view of the vibration assembly in some embodiments.

FIG. 10 is an exploded structural view of the vibration assembly in some embodiments.

### DETAILED DESCRIPTION

The following clearly and completely describes the technical solutions in some embodiments of the disclosure with reference to the accompanying drawings in some embodiments of the disclosure. Apparently, the described embodiments are merely some embodiments of the disclosure, rather than all embodiments. All other embodiments obtained by a person of ordinary skill in the art based on the embodiments of the disclosure without creative efforts shall fall within the protection scope of the disclosure.

It should be noted that the terms "first", "second", etc. in the description and claims of the disclosure and the above drawings are used to distinguish different objects rather than to describe a specific order. In addition, the terms "include" and "have" and any variations thereof are intended to cover non-exclusive inclusion.

In the description of the disclosure, directions or positional relationships indicated by "middle", "upper", "lower", "front", "rear", "vertical", "horizontal", "top", "bottom", "inner", "outer", etc. are based on directions or positional relationships shown in the drawings, merely to facilitate description of the disclosure and simplify the description, rather than to indicate or imply that the device or element must have a specific direction or be constructed or operated in a specific direction. Therefore, they cannot be understood as limitations to the disclosure. The positional relationships of components are appropriately changed according to the described directions of the components.

In the description of the disclosure, unless otherwise expressly specified and defined, the terms "install", "connect", and "link" should be understood in a broad sense. For example, they may be fixed connections, or detachable connections, or integrated connections; they may be mechanical connections, or electrical connections; they may be direct connections, or indirect connections via an intermediate medium, or internal communication between two elements. For a person of ordinary skill in the art, the specific meanings of the above terms in the disclosure can be understood according to specific circumstances.

With social development and improvement of living standards, people are paying increasing attention to their body shape and have a growing need for body management. Abdominal massage belts are therefore gaining popularity. An abdominal massage belt is a device that massages the abdomen through mechanical vibration, rotating massage heads, or electrical pulses; it can help promote gastrointestinal peristalsis, relieve muscle fatigue, and assist weight loss.

In related art, the massage area of massage belts is limited and the massage effect is poor.

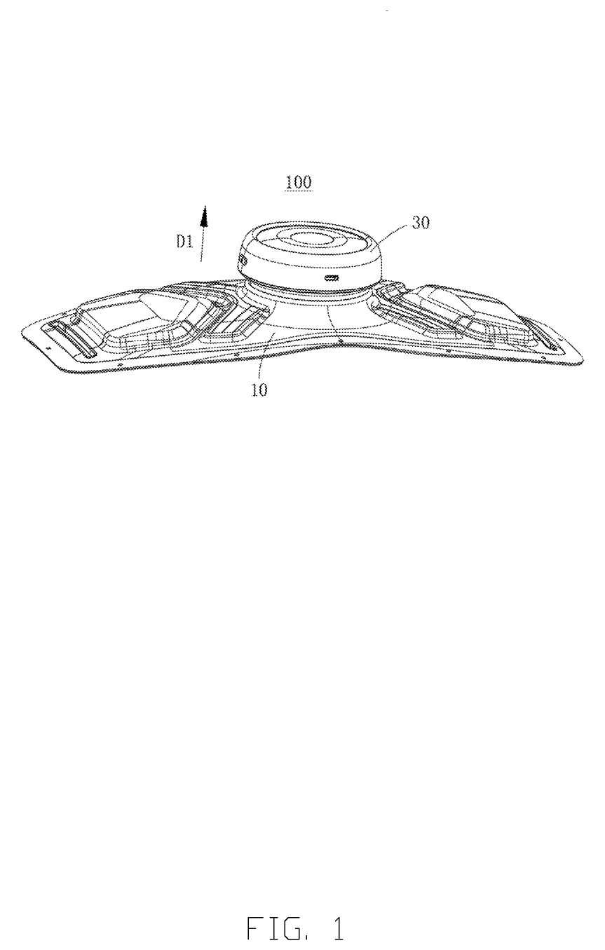

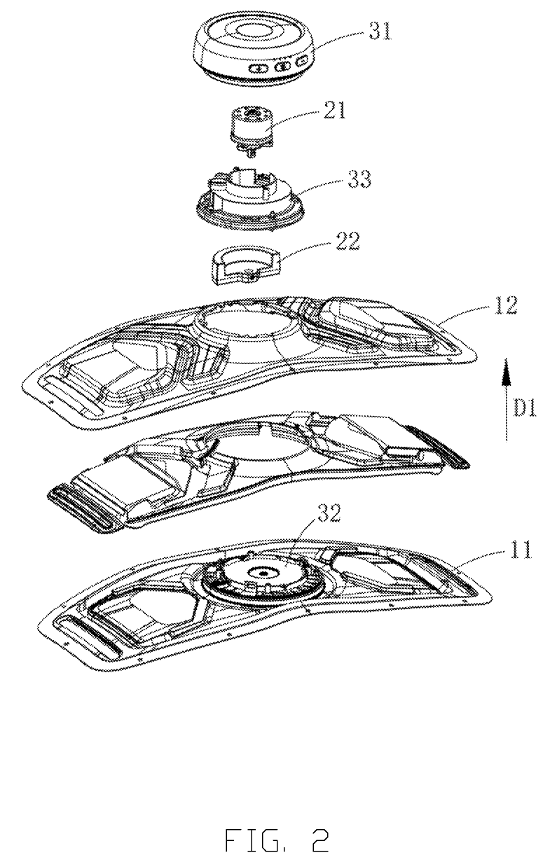

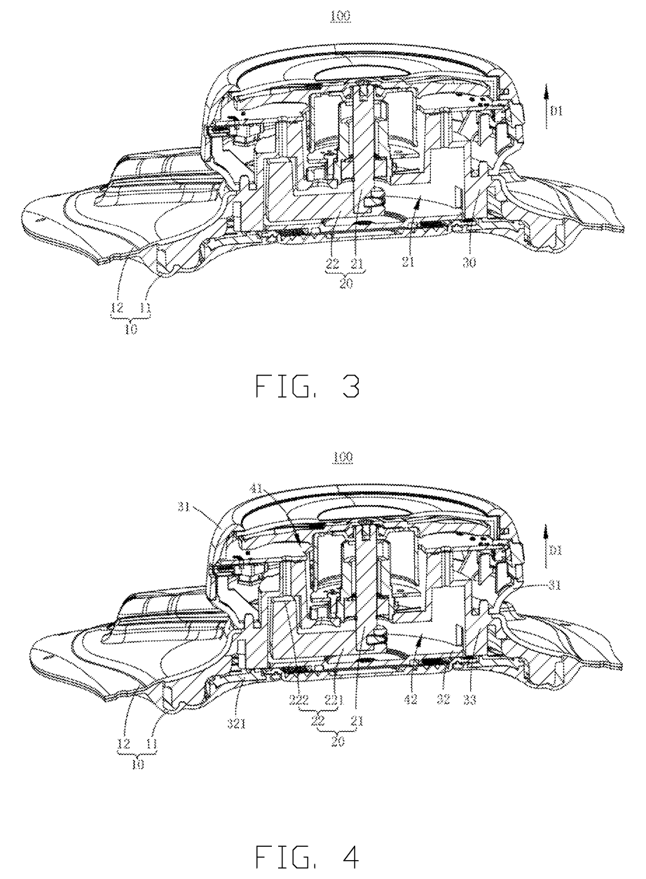

Refer to FIGS. 1-5. FIG. 1 is a schematic structural view of a massage belt in some embodiments. FIG. 2 is an exploded structural view of the massage belt in some embodiments. FIG. 3 is a first cross-sectional structural view of the massage belt in some embodiments. FIG. 4 is a second cross-sectional structural view of the massage belt in some embodiments. FIG. 5 is a third cross-sectional structural view of the massage belt in some embodiments.

The disclosure provides a massage belt 100 to solve the technical problem in related art that the massage area of massage belts is limited and the massage effect is poor.

It should be noted that the massage belt 100 provided by the disclosure is used to massage a target area of a user, wherein the target area includes but is not limited to the user's abdomen, waist, or other positions. The disclosure takes the user's target area as the waist for example, which should not be construed as a limitation to the disclosure.

In some embodiments, the massage belt 100 includes a belt body 10 and a vibration assembly 20. The belt body 10 is made of a flexible material. The vibration assembly 20 includes a motor 21 and an eccentric weight 22, and the motor 21 is drivingly connected to the eccentric weight 22. The vibration assembly 20 is connected to the belt body 10, and the vibration assembly 20 is configured to, when the eccentric weight 22 rotates, generate a periodic vibration and transmit the vibration to the belt body 10, a vibration direction of the periodic vibration being perpendicular to a first direction D1.

In some embodiments, the vibration assembly 20 includes the motor 21 and the eccentric weight 22, the motor 21 is configured to drive the eccentric weight 22 to rotate, so that the vibration assembly 20 generates a periodic vibration. The principle that the motor 21 drives the eccentric weight 22 to rotate to generate vibration is based on a periodically unbalanced centrifugal force effect. In some embodiments, a mass center (center of mass distribution) of the eccentric weight 22 is geometrically offset from a rotation axis. When the motor 21 drives the eccentric weight 22 to rotate at a constant speed, the eccentric mass generates a centrifugal force whose direction changes with an angle due to the offset of the mass center from the rotation axis. The centrifugal force forms a periodically changing exciting force, forcing the motor 21 and the connected belt body 10 to generate forced vibration. In other words, the offset of the mass center of the eccentric weight 22 causes the centrifugal force vector to change in a sinusoidal law during rotation. A combined force of horizontal and vertical components forms a simple harmonic vibration load, driving the belt body 10 to generate mechanical vibration of the same frequency. The vibration is transmitted to the target area through the belt body 10, and the target area is massaged by vibration.

The vibration assembly 20 is connected to the belt body 10. In some embodiments, the vibration assembly 20 and the belt body 10 include but are not limited to direct connection or indirect connection. The vibration assembly 20 and the belt body 10 are indirectly connected for example, and connection structures respectively connecting the vibration assembly 20 and the belt body 10 will be described in detail below, which should not be construed as a limitation to the disclosure.

Further, in some embodiments, the belt body 10 of the massage belt 100 is used to fit the user's target area, and the vibration assembly 20 is spaced from the user's target area. The vibration assembly 20 is configured to drive the belt body 10 to vibrate and then massage the user's target area, so as to achieve massage of the target area.

In some embodiments, the number of the vibration assemblies 20 is one, and the belt body 10 can be driven to vibrate by the one vibration assembly 20.

An orthographic projection area of the belt body 10 on a horizontal plane is larger than an orthographic projection area of the vibration assembly 20 on the horizontal plane, wherein the horizontal plane is a plane perpendicular to an output shaft of the motor 21. The belt body 10 has a relatively large massage area. By driving the belt body 10 through the vibration assembly 20 to massage the target area, the massage area on the target area can be increased while ensuring that the vibration assembly 20 has a small volume.

Further, the belt body 10 is made of a flexible material, which can fit a curve of the target area and enhance massage uniformity of the massage belt 100. In some embodiments, the belt body 10 made of the flexible material has good extensibility and deformability, and can closely fit arcs and contours of the abdomen or waist, avoiding local pressure on the target area caused by edges or rigid contact of traditional hard materials. Moreover, the flexibility of the belt body 10 enables the periodic vibration generated by the vibration assembly 20 to be more uniformly transmitted to the target area (such as intestines and stomach, waist muscles, and acupoints of the abdomen), reducing loss of vibration energy during transmission, ensuring consistent massage force distribution, and improving accuracy of the massage effect.

Further, the belt body 10 made of the flexible material can improve wearing comfort of the massage belt 100. In some embodiments, the belt body 10 made of the flexible material can serve as a vibration buffer medium. When the motor 21 drives the eccentric weight 22 to rotate to generate periodic vibration, part of impact force is absorbed by elastic deformation of the flexible material of the belt body 10 itself, preventing the vibration from directly acting on bones or soft tissues of the target area to cause discomfort (such as tingling or numbness). Moreover, the belt body 10 made of the flexible material can reduce a friction coefficient when contacting the user's target area, reducing problems such as redness and allergy caused by long-time wearing. Meanwhile, flexibility of the belt body 10 made of the flexible material allows the massage belt 100 to naturally swing with the target area when the user moves or performs physical activities, reducing friction and binding feeling between the belt body 10 and the target area, and being suitable for long-time wearing by the user.

Further, the belt body 10 made of the flexible material can adapt to waists of different users, improving applicability of the massage belt 100. In some embodiments, characteristics of the flexible material of the belt body 10 enable the belt body 10 to stretch or contract to fit waist sizes of different users, avoiding problems of tightness or looseness of traditional fixed-size belts. The belt body 10 of the disclosure can ensure stable wearing effects for users of different body types through elastic deformation, expanding applicable populations of the massage belt 100.

In some embodiments, a material of the belt body 10 includes but is not limited to one or more of silicone, sponge, thermoplastic urethane (TPU), elastic fabric, or other materials.

In some embodiments, a hardness range of the belt body 10 is 30 Shore A to 70 Shore A. For example, the hardness of the belt body 10 may be 30 Shore A, 32 Shore A, 35 Shore A, 38 Shore A, 40 Shore A, 41 Shore A, 45 Shore A, 47 Shore A, 50 Shore A, 53 Shore A, 55 Shore A, 56 Shore A, 60 Shore A, 64 Shore A, 65 Shore A, 69 Shore A, 70 Shore A, or other values within 30 Shore A to 70 Shore A, which is not limited in the disclosure.

The vibration assembly 20 generates a periodic vibration and transmits the vibration to the belt body 10, wherein the vibration direction of the periodic vibration is perpendicular to the first direction D1, so that the vibration assembly 20 produces a lateral kneading-and-shaking vibration effect, which can drive the target area (such as the abdomen) to shake in a large area, assist the user in achieving abdominal fat reduction and other slimming effects, and the kneading-and-shaking massage driven by the vibration assembly 20 and the belt body 10 can simulate intestinal peristalsis, enhance gastrointestinal motility of the user, promote digestion and absorption of food by the gastrointestinal tract of the user, and alleviate symptoms such as gastrointestinal discomfort.

In the massage belt provided by the disclosure, the belt body 10 is made of a flexible material, the motor 21 and the eccentric weight 22 of the vibration assembly 20 are drivingly connected, the vibration assembly 20 is connected to the belt body 10, and the vibration assembly 20 is configured to, when the eccentric weight 22 rotates, generate a periodic vibration and transmit the vibration to the belt body 10. The belt body 10 has a relatively large massage area; by driving the belt body 10 through the vibration assembly 20 to massage the target area, the massage area on the target area is increased. The belt body 10 made of a flexible material can improve wearing comfort of the massage belt 100, and the flexible belt body 10 can better fit the target area, thereby improving massage uniformity and massage effect of the massage belt 100.

Wherein the vibration assembly 20 is arranged in a middle region of the belt body 10. When the vibration assembly 20 transmits vibration, transmission on two sides of the belt body 10 is uniform, avoiding discomfort or imbalance of the target area caused by uneven vibration transmission, and improving massage uniformity of the massage belt 100.

Refer to FIGS. 1-5. In some embodiments, the massage belt 100 further includes a housing assembly 30, the vibration assembly 20 is arranged inside and connected to the housing assembly 30, the housing assembly 30 is connected to the belt body 10, and the vibration assembly 20 and the housing assembly 30 protrude from the belt body 10, the vibration assembly 20 is configured to drive the housing assembly 30 to vibrate and thereby drive the belt body 10 to vibrate.

The vibration assembly 20 is arranged inside and connected to the housing assembly 30. In some embodiments, the vibration assembly 20 is installed inside the housing assembly 30 and is rigidly fixedly connected to the housing assembly 30 through a mechanical connection structure. A fixed connection manner of the vibration assembly 20 and the housing assembly 30 includes but is not limited to screw fixation, buckle engagement, or other fixed manners. The rigid fixed connection of the vibration assembly 20 and the housing assembly 30 ensures that vibration energy generated when the motor 21 of the vibration assembly 20 drives the eccentric weight 22 to rotate can be transmitted to the housing assembly 30 without loss or with low loss, avoiding vibration attenuation or abnormal noise caused by loose connection between the vibration assembly 20 and the housing assembly 30.

Further, in some embodiments, when the vibration assembly 20 works, the motor 21 drives the eccentric weight 22 to rotate at a high speed, and utilizes an unbalanced centrifugal force effect generated by offset of a mass center of the eccentric weight 22, so that the vibration assembly 20 itself generates periodic mechanical vibration. The vibration is amplified and conducted through a rigid structure of the housing assembly 30, and is converted into overall regular vibration of the housing assembly 30. Moreover, since the housing assembly 30 is fixedly connected to the belt body 10, vibration energy of the housing assembly 30 is further transmitted to the belt body 10, so that the belt body 10 synchronously vibrates with the housing assembly 30, and finally the vibration is uniformly applied to the user's target area through a flexible contact surface of the belt body 10.

In some embodiments, by providing the housing assembly 30, the housing assembly 30 serves as an intermediate medium, which not only provides a stable installation carrier for the vibration assembly 20, but also transmits vibration of the vibration assembly 20 to the belt body 10. Moreover, in the massage belt 100 of the disclosure, by combining the flexible belt body 10 and the rigid housing assembly 30, vibration of the vibration assembly 20 can maintain energy intensity during transmission, and can adapt to a human body curved surface through deformation of the material of the belt body 10, avoiding problems such as contact dead angles or local pressure of traditional rigid massagers.

The housing assembly 30 of the massage belt 100 serves as a vibration conduction hub. The vibration assembly 20 (including the motor 21 and the eccentric weight 22) is arranged inside the housing assembly 30. The housing assembly 30 and the vibration assembly 20 are rigidly connected to form a vibration unit. An outer side of the housing assembly 30 is fixedly connected to the flexible belt body 10, ensuring efficient transmission of vibration energy of the vibration assembly 20 and improving massage uniformity and wearing comfort of the massage belt 100. When the vibration assembly 20 works, the motor 21 drives the eccentric weight 22 to rotate to generate unbalanced centrifugal force, causing vibration of the vibration assembly 20 itself; the vibration is conducted to the belt body 10 through the rigid structure of the housing assembly 30, so that the belt body 10 synchronously generates periodic vibration with the housing assembly, and finally mechanical vibration is uniformly applied to the user's target area. The vibration assembly 20, the housing assembly 30, and the belt body 10 are configured by combining rigid and flexible structures, which ensures vibration efficiency, and improves fitting performance of the massage belt 100 to the user's target area, massage effect, and wearing comfort.

In some embodiments, the massage belt 100 further includes a control component 50, the control component 50 and the vibration assembly 20 are both arranged in the housing assembly 30. In some embodiments, the control component 50 is fixed between the outer casing 31 and the second mounting seat 33, the control component 50 is electrically connected to the vibration assembly 20, and the control component 50 is configured to control the vibration assembly 20 to vibrate.

Refer to FIGS. 1-5. In some embodiments, the belt body 10 includes a first body 11 and a second body 12 arranged along the first direction D1, the first body 11 and the second body 12 are respectively connected to the housing assembly 30, and the first body 11 and the second body 12 are configured to vibrate under drive of the housing assembly 30.

Wherein the first direction D1 is a direction away from a horizontal placement surface in a height direction of the housing assembly 30 when the housing assembly 30 is placed on the horizontal placement surface (as shown in FIG. 1).

The first body 11 and the second body 12 are fixedly connected, so that the belt body 10 formed by the first body 11 and the second body 12 can transmit vibration energy of the housing assembly 30 to the target area without loss or with low loss. In some embodiments, a connection manner of the first body 11 and the second body 12 includes but is not limited to adhesion, edge sewing, hot-melt pressing, or other connection manners.

In some embodiments, materials of the first body 11 and the second body 12 are the same. In some embodiments, materials of the first body 11 and the second body 12 may also be different, which is not limited in the disclosure. For example, the first body 11 is used to fit the user's target area, the first body 11 may be made of a skin-friendly material, and the second body 12 is away from the user's target area and may be made of a material with high elasticity, so as to ensure stability of vibration transmission of the belt body 10.

Refer to FIGS. 1-5. Further, in some embodiments, the housing assembly 30 includes an outer casing 31 and a first mounting seat 32 connected to each other, the outer casing 31 and the first mounting seat 32 are arranged along the first direction D1, the outer casing 31 and the first mounting seat 32 together enclose a receiving space 40, the vibration assembly 20 is arranged in the receiving space 40, the second body 12 is connected to the outer casing 31 or the first mounting seat 32, and the first body 11 is connected to the outer casing 31 or the first mounting seat 32.

The housing assembly 30 includes the connected outer casing 31 and first mounting seat 32. Wherein the outer casing 31 is located on an outer side of the massage belt 100 (a side of the massage belt 100 away from the target area). In some embodiments, the vibration assembly 20 is arranged on a side of the outer casing 31 facing the first mounting seat 32, the motor 21 of the vibration assembly 20 is mounted on the outer casing 31, and the motor 21 is directly connected to the eccentric weight 22. The vibration assembly 20 is arranged on the outer casing 31 and is fixedly connected to the outer casing 31. In some embodiments, a fixed connection manner of the vibration assembly 20 and the outer casing 31 includes but is not limited to buckle connection, screw fixation, or other rigid connection manners.

The first mounting seat 32 is located on an inner side of the massage belt 100 (a side of the massage belt 100 close to the target area). The first mounting seat 32 is connected to the outer casing 31 through buckle connection, screw fixation, or other rigid connection manners. The first mounting seat 32 transmits vibration of the vibration assembly 20 to the belt body 10 through the outer casing 31.

The outer casing 31 and the first mounting seat 32 together enclose the receiving space 40, and the receiving space 40 can be used to accommodate the vibration assembly 20. By arranging the vibration assembly 20 in the receiving space 40, on one hand, the vibration assembly 20 can be protected from collision, dust, and other influences from the outside; on the other hand, it is helpful to better transmit vibration generated by the vibration assembly 20 to the entire housing assembly 30.

The second body 12 is connected to the outer casing 31 or the first mounting seat 32, and the first body 11 is connected to the outer casing 31 or the first mounting seat 32. In some embodiments, the second body 12 is connected to the outer casing 31, and the first body 11 is connected to the first mounting seat 32. In some embodiments, the first body 11 and the second body 12 may both be connected to the outer casing 31, or the first body 11 and the second body 12 may both be connected to the first mounting seat 32, which is not limited in the disclosure.

When the first body 11 is connected to the first mounting seat 32, since the first mounting seat 32 is relatively close to the user's target area compared to the outer casing 31, the first mounting seat 32 drives the first body 11 to vibrate, achieving better vibration restoration and improving a vibration massage effect of the first body 11.

Refer to FIGS. 1-5. Further, in some embodiments, the housing assembly 30 further includes a second mounting seat 33, the second mounting seat 33 is arranged between the first mounting seat 32 and the outer casing 31. It should be noted that the second mounting seat 33 is arranged between the first mounting seat 32 and the outer casing 31. In some embodiments, the second mounting seat 33 is respectively connected to the outer casing 31 and the first mounting seat 32. In some embodiments, the second mounting seat 33 may be connected to the first mounting seat 32 and spaced from the outer casing 31, or the second mounting seat 33 may be connected to the outer casing 31 and spaced from the first mounting seat 32, which is not limited in the disclosure.

The motor 21 is arranged on the second mounting seat 33, the outer casing 31 and the second mounting seat 33 together enclose a first receiving space 41, the motor 21 is arranged in the first receiving space 41, the second mounting seat 33 and the first mounting seat 32 together enclose a second receiving space 42, and the eccentric weight 22 is arranged in the second receiving space 42.

Similarly, the outer casing 31 is located on the outer side of the massage belt 100 (the side of the massage belt 100 away from the target area), the first mounting seat 32 is located on the inner side of the massage belt 100 (the side of the massage belt 100 close to the target area), and the second mounting seat 33 is arranged between the outer casing 31 and the first mounting seat 32.

In some embodiments, the second mounting seat 33 is fixed on the first mounting seat 32, and the outer casing 31 is fixed on the second mounting seat 33, so as to achieve mutual fixation among the outer casing 31, the second mounting seat 33, and the first mounting seat 32. In some embodiments, the outer casing 31 and the first mounting seat 32 may be fixedly connected, and the second mounting seat 33 may be clamped and fixed between the outer casing 31 and the first mounting seat 32, which is not limited in the disclosure.

In some embodiments, the second mounting seat 33 and the first mounting seat 32 are fixedly connected by bolts, and the outer casing 31 and the second mounting seat 33 are fixedly connected by bolts. In some embodiments, the second mounting seat 33 and the first mounting seat 32 may also be connected by buckle connection, welding, or other fixed manners, and the outer casing 31 and the second mounting seat 33 may also be connected by buckle connection, welding, or other fixed manners, which is not limited in the disclosure.

The motor 21 is arranged in the first receiving space 41 enclosed by the outer casing 31 and the second mounting seat 33, and the eccentric weight 22 is arranged in the second receiving space 42 enclosed by the second mounting seat 33 and the first mounting seat 32. In other words, the motor 21 and the eccentric weight 22 are respectively arranged on two sides of the second mounting seat 33, and an output shaft of the motor 21 passes through the second mounting seat 33 and is connected to the eccentric weight 22. By arranging the motor 21 and the eccentric weight 22 in different receiving spaces 40, mutual interference between the motor 21 and the eccentric weight 22 can be avoided, improving working stability of the vibration assembly 20.

In some embodiments, the second mounting seat 33 includes a first receiving groove 331 and a second receiving groove 332 arranged back-to-back, the motor 21 is arranged in the first receiving groove 331 and connected to a bottom wall of the first receiving groove 331, the eccentric weight 22 is arranged in the second receiving groove 332, and the output shaft of the motor 21 passes through the first receiving groove 331 and the second receiving groove 332 and is connected to the eccentric weight 22.

A first receiving groove 331 is arranged on one side of the second mounting seat 33, the motor 21 is arranged in the first receiving groove 331 and is fixedly connected to the bottom wall of the first receiving groove 331, and a groove wall of the first receiving groove 331 can also be used to install a driving circuit board of the motor 21 or other structures. The groove wall of the first receiving groove 331 can be used to accommodate and shield at least part of the motor 21, avoiding interference between other structural components in the massage belt 100 and the motor 21, and improving working stability of the motor 21.

Similarly, a second receiving groove 332 is arranged on the other side of the second mounting seat 33, the eccentric weight 22 is arranged in the second receiving groove 332, and a groove wall of the second receiving groove 332 can be used to accommodate and shield at least part of the eccentric weight 22, avoiding interference between other structural components in the massage belt 100 and the eccentric weight 22, and improving rotation stability of the eccentric weight 22.

The second mounting seat 33 is provided with the back-to-back first receiving groove 331 and second receiving groove 332, which are respectively used to accommodate the motor 21 and the eccentric weight 22, so that the motor 21 and the eccentric weight 22 can be orderly arranged in a limited space, avoiding mutual interference between components. A compact structural design can make the massage belt 100 more compact and lightweight, facilitating wearing and use by the user. By respectively arranging the motor 21 and the eccentric weight 22 in the opposite first receiving groove 331 and second receiving groove 332, and allowing the output shaft of the motor 21 to directly pass through the two receiving grooves to connect the eccentric weight 22, the layout of the entire vibration assembly 20 is more compact, reducing space occupied by the vibration assembly 20 in the first direction D1 (thickness direction), and helping to achieve a thin and light design of the massage belt 100.

Moreover, the designs of the first receiving groove 331 and the second receiving groove 332 form a modular structure, and the motor 21 and the eccentric weight 22 can be independently installed into corresponding receiving grooves. The modular design facilitates assembly operations in a production process of the massage belt 100, improving production efficiency. Meanwhile, when the massage belt 100 fails or needs maintenance, the motor 21 and the eccentric weight 22 can be conveniently taken out from respective receiving grooves for repair or replacement. Further, bottom walls of the first receiving groove 331 and the second receiving groove 332 provide clear installation positions and support surfaces for the motor 21 and the eccentric weight 22, ensuring positioning accuracy during installation of the motor 21 and the eccentric weight 22, helping to ensure connection accuracy between the output shaft of the motor 21 and the eccentric weight 22, and further improving working stability of the vibration assembly 20.

Further, integrating the motor 21 and the eccentric weight 22 in the two receiving grooves of the second mounting seat 33 makes a vibration source of the vibration assembly 20 more concentrated, allowing vibration energy to be more efficiently transmitted to the second mounting seat 33, and then to the first body 11 and the second body 12 connected thereto, enhancing a vibration effect of the massage belt 100, and improving massage comfort and effectiveness.

In the massage belt 100 of the disclosure, the output shaft of the motor 21 directly passes through the first receiving groove 331 and the second receiving groove 332 and is connected to the eccentric weight 22. The direct connection shortens a power transmission path. Compared with indirect connection or long-distance transmission, power of the motor 21 can be more efficiently transmitted to the eccentric weight 22, reducing loss during power transmission, and improving energy utilization efficiency. Moreover, the direct connection of the output shaft of the motor 21 to the eccentric weight 22 can reduce transmission errors caused by deformation, looseness, and other factors of transmission components, enabling rotational speed and torque of the motor 21 to be accurately transmitted to the eccentric weight 22, ensuring stable rotation of the eccentric weight 22, and enabling the vibration assembly 20 to generate a stable and reliable vibration effect.

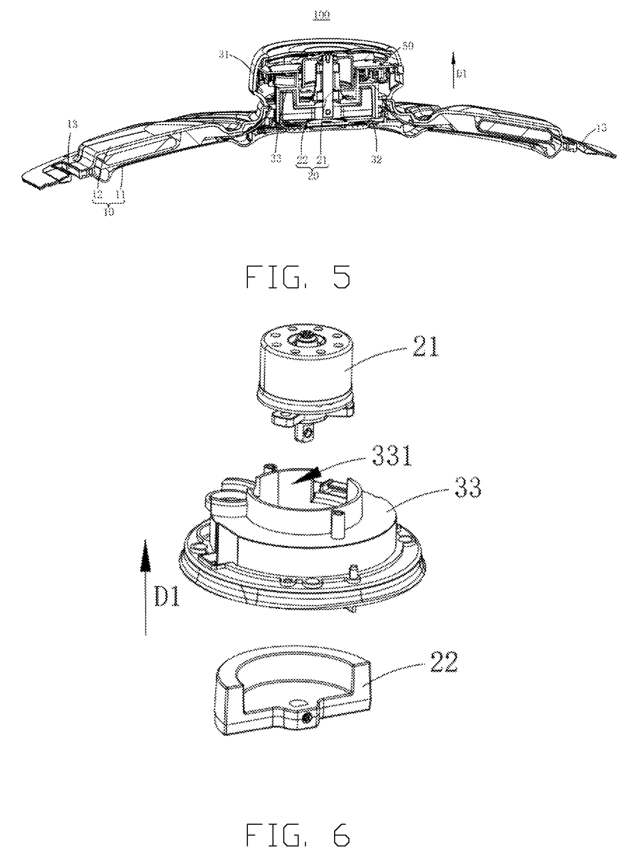

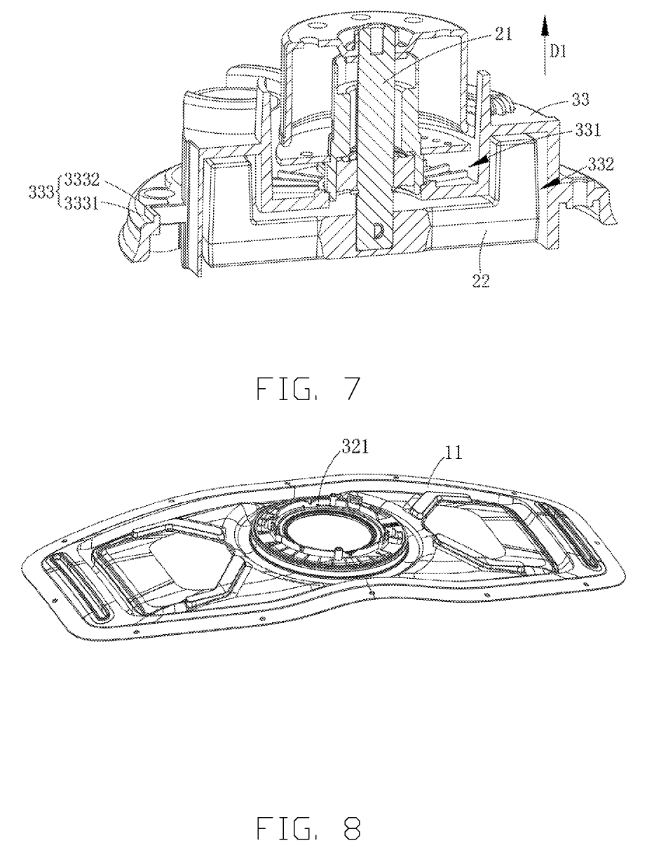

Refer to FIGS. 4-7. FIG. 6 is an exploded structural view of a vibration assembly and a second mounting seat in some embodiments. FIG. 7 is a structural view of the vibration assembly mounted on the second mounting seat in some embodiments.

In some embodiments, the second body 12 is connected to the second mounting seat 33, the first body 11 is connected to the first mounting seat 32, the vibration assembly 20 is configured to drive the second mounting seat 33 to vibrate and thereby drive the second body 12 to vibrate, and the vibration assembly 20 is configured to drive the first mounting seat 32 to vibrate and thereby drive the first body 11 to vibrate.

When the vibration assembly 20 vibrates, the vibration assembly 20 drives the first mounting seat 32 to vibrate through the second mounting seat 33, thereby driving the first body 11 to vibrate. Meanwhile, the vibration assembly 20 drives the second body 12 to vibrate through the second mounting seat 33. The first body 11 and the second body 12 are connected, thereby driving the first body 11 to vibrate. The first body 11 has two vibration transmission parts: one is a middle region of the first body 11 (a part connected to the second mounting seat 33), and the other is an edge region of the first body 11 (a part connected to the second body 12), so that the first body 11 can receive vibration transmitted by two structural components, improving utilization efficiency of vibration energy of the vibration assembly 20. Moreover, the first body 11 is used to fit the user's target area, and the first body 11 can receive vibration transmitted by the two structural components, so that the user's target area can also feel vibration in two directions, improving depth and coverage of massage of the target area.

In some embodiments, the second body 12 is arranged between the outer casing 31 and the second mounting seat 33, and the outer casing 31 and the second mounting seat 33 are connected by screws and clamp-fix the second body 12.

The outer casing 31 and the second mounting seat 33 are connected by screws and clamp-fix the second body 12. Screw connection can provide high-strength mechanical fastening force, preventing the second body 12 from loosening or shifting during vibration, and ensuring structural stability of the massage belt 100. Moreover, the second body 12 can also serve as a buffer layer to reduce vibration noise of the second mounting seat 33, and the second body 12 can also serve as a seal to reduce a gap between the outer casing 31 and the second mounting seat 33, preventing dust and liquid from entering an internal cavity of the massage belt 100 from the gap between the outer casing 31 and the second mounting seat 33.

Further, an outer periphery of the second mounting seat 33 is provided with a connecting part 333 in a ring shape, the connecting part 333 includes a connecting surface 3331 and an annular rim 3332, the annular rim 3332 is arranged on the connecting surface 3331 and protrudes from the connecting surface 3331 in a direction away from the first mounting seat 32, the connecting part 333 is connected to the outer casing 31 by screws so as to squeeze and fix the second body 12 between the connecting surface 3331 and the outer casing 31.

In some embodiments, a dimension of the annular rim 3332 along the first direction D1 is smaller than a thickness of the second body 12. So that when the connecting part 333 and the outer casing 31 are fixedly connected, the second body 12 is squeezed by the connecting part 333 and the outer casing 31, thereby achieving clamping and fixing of the second body 12 between the connecting surface 3331 and the outer casing 31. In some embodiments, a dimension of the annular rim 3332 along the first direction D1 may also be greater than or equal to the thickness of the second body 12, and a protrusion is arranged on the annular rim 3332 to squeeze and fix the second body 12 between the connecting part 333 and the outer casing 31, which is not limited in the disclosure.

Refer to FIGS. 4, 5, and 8. FIG. 8 is a structural view of a second body and a first mounting seat in some embodiments.

In some embodiments, the first mounting seat 32 includes a base 321, the base 321 and the first body 11 are formed by two-shot injection molding, and the base 321 and the second mounting seat 33 are fixedly connected by screws.

In some embodiments, the base 321 and the first body 11 are formed by two-shot injection molding through an over-molding process. Wherein, the two-shot injection molding refers to first injection molding the base 321, then placing the base 321 into a mold, and injection molding the first body 11 on a surface or a specific region of the base 321, so that the two are fused and bonded into an integral component through material melting. In other words, the base 321 and the first body 11 form an integrated structure. For ease of description, they are separately named in the disclosure, which should not be construed as a limitation to the disclosure.

Wherein the base 321 is made of a hard material, the base 321 and the second mounting seat 33 are fixedly connected by screws, and screw connection can provide high-strength mechanical fastening force, preventing the first mounting seat 32 from loosening or shifting relative to the second mounting seat 33 during vibration, and ensuring structural stability of the massage belt 100.

The second body 12 is made of a flexible material, the base 321 is made of a hard material, and the base 321 and the second body 12 are formed by two-shot injection molding, so that no obvious gap exists at a joint between the base 321 and the second body 12, preventing dust and sweat from entering an interior of the massage belt 100 from the base 321 and the second body 12, and improving sealing performance of the massage belt 100. Moreover, the second body 12 and the base 321 are integrally formed by two-shot injection molding, no additional assembly process is required for the second body 12, facilitating simplification of assembly steps of the massage belt 100.

In some embodiments, the base 321 and the first body 11 may not be formed by two-shot injection molding, but may be two separate components and be fixed by other fixed connection manners.

For example, in some embodiments, a plurality of fixing holes are arranged on the base 321, the first body 11 is provided with a plurality of fixing parts, and the fixing parts are arranged in the fixing holes and abut against inner walls of the fixing holes, so as to fix the first body 11 relative to the base 321.

In some embodiments, the first body 11 and the base 321 are fixedly connected by interference fit. In some embodiments, the first body 11 and the base 321 may also be connected by adhesion, hot-melt pressing, or other connection manners, which is not limited in the disclosure.

In traditional vibration massagers, a rotation axis of an eccentric weight is usually parallel to a target area, and when the eccentric weight rotates, vibration perpendicular to the target area (such as up-and-down vibration) is generated, and a touch feeling is high-frequency tremor, resulting in poor massage effect.

Refer to FIGS. 1-7. In some embodiments, a rotation axis of the eccentric weight 22 is parallel to the first direction D1. In other words, the rotation axis of the eccentric weight 22 is perpendicular to the user's target area. When the rotation axis of the eccentric weight 22 is perpendicular to the user's target area (assuming the target area is a horizontal plane, such as abdominal skin surface), a motion trajectory of the eccentric weight 22 presents circular motion around the rotation axis, causing the vibration assembly 20 to generate a lateral shaking and kneading vibration effect, rather than simple up-and-down vibration.

In some embodiments, since the rotation axis of the eccentric weight 22 is perpendicular to the user's target area, a direction of centrifugal force of the eccentric weight 22 periodically changes in a horizontal plane (such as from left to right and then from right to left in a cycle), thereby driving the housing assembly 30 and the belt body 10 to reciprocally shake in a horizontal direction, so that the belt body 10 fits the user's target area and simultaneously drives the target area to swing left and right or in a ring shape, forming an action similar to "shaking" or "kneading", so as to produce a kneading-and-shaking massage effect, forming an action similar to "hand shaking" or "kneading", and enabling the belt body 10 to be closer to a manual kneading or toggling feeling.

The rotation axis of the eccentric weight 22 is perpendicular to the user's target area, and the belt body 10 fits the user's target area and simultaneously drives the target area to swing left and right or in a ring shape, rather than simply vibrating. For example, every time the eccentric weight 22 rotates one circle, the belt body 10 completes a reciprocal motion of "left-right-left" in a horizontal direction and a reciprocal motion of "up-down-up" in a vertical direction, similar to a palm transversely kneading the target area one circle.

The rotation axis of the eccentric weight 22 is perpendicular to the user's target area, so that the belt body 10 performs lateral kneading-and-shaking massage on the user's target area. When the massage belt 100 is used to massage the user's waist, the kneading-and-shaking massage of the massage belt 100 can drive waist muscle groups to perform passive stretching or squeezing, which is beneficial to dissipating lactic acid accumulated after sitting for a long time or exercising, and reducing stiffness. When the massage belt 100 is used to massage the user's abdomen, the kneading-and-shaking massage of the massage belt 100 can drive the abdomen to shake in a large area, assist the user in achieving abdominal fat reduction and other slimming effects, and the kneading-and-shaking massage of the massage belt 100 can simulate intestinal peristalsis, enhance gastrointestinal motility of the user, promote digestion and absorption of food by the gastrointestinal tract of the user, and alleviate symptoms such as gastrointestinal discomfort.

Traditional vertical vibration easily produces a "tingling feeling" or "numbness", while the massage belt 100 of the disclosure performs massage through lateral kneading-and-shaking, and the lateral kneading-and-shaking action is closer to a manual massage trajectory, fits acceptance of the human body to actions such as "kneading, pushing, and plucking", and can improve wearing comfort and massage effect of the massage belt 100.

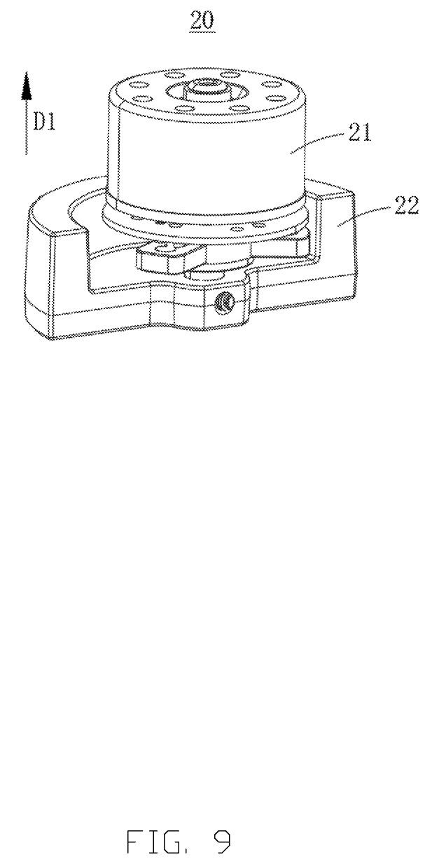

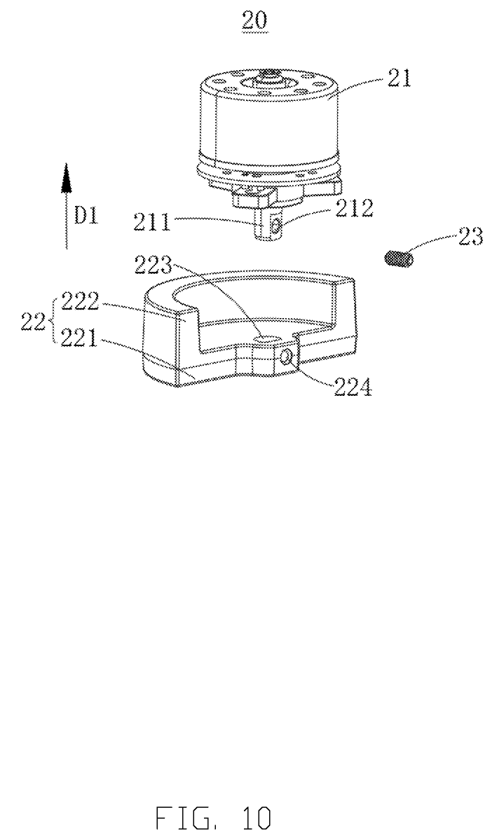

Refer to FIGS. 1-10. FIG. 9 is a structural view of a vibration assembly in some embodiments. FIG. 10 is an exploded structural view of the vibration assembly in some embodiments.

In some embodiments, the eccentric weight 22 is provided with an insertion hole 223 in an axial direction, the insertion hole 223 is a non-circular hole, an output shaft of the motor 21 includes an installation section 211, a shape of the installation section 211 matches a shape of the insertion hole 223, and the installation section 211 is accommodated in the insertion hole 223, so that the output shaft of the motor 21 is drivingly connected to the eccentric weight 22.

The insertion hole 223 and the installation section 211 have matching shapes and are both non-circular, so that the output shaft of the motor 21 can better drive the eccentric weight 22 to rotate.

Refer to FIGS. 1-10. In some embodiments, the vibration assembly 20 further includes a locking member 23, the eccentric weight 22 is provided with a threaded hole 224 in a radial direction, the locking member 23 is threadedly connected to the threaded hole 224, and the locking member 23 passes through the eccentric weight 22 and abuts against the output shaft of the motor 21, so as to lock the eccentric weight 22 on the output shaft of the motor 21, and fix the eccentric weight 22 and the output shaft of the motor 21 to each other.

Refer to FIGS. 1-10. Further, in some embodiments, the output shaft of the motor 21 is provided with a receiving groove 212 in a radial direction, and the receiving groove 212 is used to accommodate the locking member 23.

In some embodiments, the locking member 23 passes through the threaded hole 224 and extends into the receiving groove 212, and abuts against a bottom wall of the receiving groove 212, so as to lock the eccentric weight 22 on the output shaft of the motor 21. A groove wall of the receiving groove 212 can be used to abut against the locking member 23, so as to hang the eccentric weight 22 on the output shaft of the motor 21. Even when the locking member 23 and a threaded connection of the threaded hole 224 of the eccentric weight 22 are loosened, the receiving groove 212 can abut against the locking member 23 and fix the eccentric weight 22 on the output shaft of the motor 21, improving connection stability and firmness between the eccentric weight 22 and the output shaft of the motor 21.

Further, in some embodiments, the output shaft of the motor 21 is provided with a receiving hole in a radial direction, the locking member 23 is threadedly connected to the receiving hole and abuts against an inner wall of the insertion hole 223.

In some embodiments, the locking member 23 passes through the threaded hole 224 and the receiving hole, and abuts against the inner wall of the insertion hole 223, so as to lock the eccentric weight 22 on the output shaft of the motor 21. An inner wall of the receiving hole is threadedly connected to the locking member 23, so as to hang the eccentric weight 22 on the output shaft of the motor 21, further improving connection stability and firmness between the eccentric weight 22 and the output shaft of the motor 21.

Refer to FIG. 4. Further, in some embodiments, a distance between an end of the eccentric weight 22 close to the first mounting seat 32 and the first mounting seat 32 is α. In other words, a distance between a surface of the eccentric weight 22 facing the first mounting seat 32 and a surface of the first mounting seat 32 facing the eccentric weight 22 is α. In still other words, a shortest distance between the eccentric weight 22 and the first mounting seat 32 in the first direction D1 is α.

If the distance between the end of the eccentric weight 22 close to the first mounting seat 32 and the first mounting seat 32 is too large (α > 15 mm), the distance between the eccentric weight 22 and the target area is also too large, vibration energy of the eccentric weight 22 is significantly attenuated in a transmission path, and actual stimulation felt by the user's target area is weakened, easily causing itching of the user's target area. If the distance between the end of the eccentric weight 22 close to the first mounting seat 32 and the first mounting seat 32 is too small (α < 5 mm), the distance between the eccentric weight 22 and the target area is also too close, high-frequency vibration is conducted to abdominal internal organs through bones, forming strong impact stimulation, which may cause discomfort or even physiological stress reactions such as vomiting.

Therefore, in some embodiments, the distance α between the end of the eccentric weight 22 close to the first mounting seat 32 and the first mounting seat 32 satisfies: 5 mm ≤ α ≤ 15 mm. When α satisfies: 5 mm ≤ α ≤ 15 mm, the distance between the eccentric weight 22 and the target area is moderate, vibration energy of the eccentric weight 22 can be effectively transmitted, and discomfort or other reactions of the user during use can be avoided.

In some embodiments, the distance α between the end of the eccentric weight 22 close to the first mounting seat 32 and the first mounting seat 32 may be 5 mm, 6 mm, 7 mm, 8 mm, 9 mm, 10 mm, 11 mm, 12 mm, 13 mm, 14 mm, 15 mm, or other values within 5 mm to 15 mm, which is not limited in the disclosure.

Refer to FIGS. 1-10. In some embodiments, the eccentric weight 22 includes a main body portion 221 and an extension portion 222, the main body portion 221 is perpendicular to the first direction D1, and the extension portion 222 extends in a direction away from the first mounting seat 32.

The main body portion 221 is perpendicular to the first direction D1, and the extension portion 222 extends in the direction away from the first mounting seat 32. On a cross section of the eccentric weight 22, a shape of the eccentric weight 22 forms an "L"-shaped "right-angle cantilever" structure.

The extension portion 222 extending in the direction away from the first mounting seat 32 can effectively shift a mass center position of the eccentric weight 22 toward the direction away from the first mounting seat 32, thereby equivalently increasing an eccentric distance of the eccentric weight 22. A larger eccentric distance enables the eccentric weight 22 to generate stronger tangential acceleration at the same rotational speed, improving a shaking amplitude of the housing assembly 30 driven by the eccentric weight 22, and further improving a shaking amplitude and force of the belt body 10 on the target area, so as to enhance a kneading-and-shaking massage effect of the massage belt 100.

It should be noted that if a single-block eccentric weight is used to increase an eccentric distance, lateral expansion is required, which increases dimensions and volume in a direction of the massage belt 100. In some embodiments, by providing the main body portion 221 and the extension portion 222 of the eccentric weight 22, an extending direction of the extension portion 222 is parallel to the output shaft of the motor 21, which does not increase dimensions and volume of the massage belt 100 in a horizontal direction, and in a thickness direction of the massage belt 100, the motor 21 and its output shaft need to be arranged, and arrangement of the extension portion 222 does not increase dimensions and volume of the massage belt 100 in the thickness direction. While effectively extending the eccentric distance of the eccentric weight 22, the overall volume of the massage belt 100 is not increased, saving internal space of the massage belt 100.

Refer to FIGS. 1-10. In some embodiments, the massage belt 100 further includes a webbing, the belt body 10 is provided with through holes 14 on two sides, and the webbing passes through the through holes 14.

The webbing can pass through the through holes 14 on two sides of the belt body 10 to form a closed loop for fixation, so as to fix the belt body 10 on the user's target area. Even when the user performs actions such as movement, bending, or turning, the massage belt 100 is not prone to shifting or slipping, ensuring that the massage assembly 20 always acts on a correct position, and maintaining stability of the massage effect of the massage belt 100.

Further, in some embodiments, a width dimension of the webbing is D1, and D1 satisfies: 60 mm ≤ D1 ≤ 100 mm. In some embodiments, the width dimension D1 of the webbing may be 60 mm, 65 mm, 70 mm, 75 mm, 80 mm, 85 mm, 90 mm, 95 mm, 100 mm, or other dimensions within 60 mm to 100 mm, which is not limited in the disclosure.

Further, in some embodiments, a width dimension of the belt body 10 close to a side of the webbing is D2, a ratio of D1 to D2 is β, and β satisfies: 0.8 ≤ β ≤ 1.

Wherein β ≥ 0.8 can ensure that the width of the webbing is not significantly smaller than the width of the belt body 10, improving connection stability between the webbing and the belt body 10, preventing flapping of the belt body 10, and improving comfort of vibration transmission of the belt body 10. β ≤ 1 can prevent the width of the webbing from greatly exceeding the width of the belt body 10, preventing wrinkles, curling, or accumulation of redundant parts of the webbing during wearing, which affects wearing stability of the massage belt 100.

In some embodiments, "embodiment" or "embodiment manner" means that specific features, structures, or characteristics described in combination with the embodiment may be included in at least one embodiment of the disclosure. The phrase appearing in various positions in the specification does not necessarily refer to the same embodiment, or an independent or alternative embodiment exclusive of other embodiments. Those skilled in the art can explicitly and implicitly understand that the embodiments described in the disclosure may be combined with other embodiments. Moreover, it should also be understood that features, structures, or characteristics described in some embodiments of the disclosure may be combined arbitrarily under the condition of no contradiction, forming another embodiment without departing from the spirit and scope of the technical solutions of the disclosure.

The above descriptions are merely embodiment manners of the disclosure, and are not intended to limit the disclosure. Any modification, equivalent replacement, improvement, etc. made within the spirit and principles of the disclosure shall fall within the protection scope of the disclosure.

What is claimed is:

1. A massage belt, comprising:
a belt body, the belt body being made of a flexible material;
a vibration assembly, the vibration assembly comprising a motor and an eccentric weight, the motor being drivingly connected to the eccentric weight;
wherein the vibration assembly is connected to the belt body, the vibration assembly is configured to, when the eccentric weight rotates, generate a periodic vibration and transmit the vibration to the belt body, a vibration direction of the periodic vibration being perpendicular to a first direction.

2. The massage belt according to claim 1, wherein the vibration assembly is arranged in a middle region of the belt body.

3. The massage belt according to claim 1, wherein the massage belt further comprises
a housing assembly, the vibration assembly is arranged inside and connected to the housing assembly, the housing assembly is connected to the belt body, and the vibration assembly and the housing assembly protrude from the belt body; the vibration assembly is configured to drive the housing assembly to vibrate and thereby drive the belt body to vibrate.

4. The massage belt according to claim 3, wherein the belt body comprises
a first body and a second body arranged along the first direction, the first body and the second body are respectively connected to the housing assembly, and the first body and the second body are configured to vibrate under drive of the housing assembly.

5. The massage belt according to claim 4, wherein the housing assembly comprises
an outer casing and a first mounting seat connected to each other, the first mounting seat and the outer casing are arranged along the first direction, the first mounting seat and the outer casing together enclose a receiving space, the vibration assembly is arranged in the receiving space, the second body is connected to the outer casing or the first mounting seat, and the first body is connected to the outer casing or the first mounting seat.

6. The massage belt according to claim 5, wherein
the vibration assembly is arranged on a side of the outer casing facing the first mounting seat, the motor of the vibration assembly is mounted on the outer casing, and the motor is directly connected to the eccentric weight.

7. The massage belt according to claim 4, wherein the housing assembly comprises
a second mounting seat, the motor and the eccentric weight are respectively arranged on two opposite sides of the second mounting seat.

8. The massage belt according to claim 7, wherein the housing assembly further comprises
the outer casing and the first mounting seat, the second mounting seat is arranged between the first mounting seat and the outer casing, the outer casing and the second mounting seat together enclose a first receiving space, the motor is arranged in the first receiving space, the second mounting seat and the first mounting seat together enclose a second receiving space, the eccentric weight is arranged in the second receiving space;
the second body is connected to the second mounting seat, the first body is connected to the first mounting seat, the vibration assembly is configured to drive the second mounting seat to vibrate and thereby drive the second body to vibrate, and the vibration assembly is configured to drive the first mounting seat to vibrate and thereby drive the first body to vibrate.

9. The massage belt according to claim 8, wherein the second mounting seat comprises
a first receiving groove and a second receiving groove arranged back-to-back, the motor is arranged in the first receiving groove and connected to a bottom wall of the first receiving groove, the eccentric weight is arranged in the second receiving groove, and an output shaft of the motor passes through the first receiving groove and the second receiving groove and is connected to the eccentric weight.

10. The massage belt according to claim 8, wherein
the second body is arranged between the outer casing and the second mounting seat, and the outer casing and the second mounting seat are connected by screws and clamp-fix the second body.

11. The massage belt according to claim 8, wherein
an outer periphery of the second mounting seat is provided with a connecting part in a ring shape, the connecting part comprises a connecting surface and an annular rim, the annular rim is arranged on the connecting surface and protrudes from the connecting surface in a direction away from the first mounting seat, the connecting part is connected to the outer casing by screws so as to squeeze and fix the second body between the connecting surface and the outer casing.

12. The massage belt according to claim 8, wherein the first mounting seat comprises
a base, the base and the first body are formed by two-shot injection molding, and the base and the second mounting seat are fixedly connected by screws.

13. The massage belt according to claim 8, wherein the first mounting seat comprises
a base, a plurality of fixing holes are provided on the base, the first body is provided with a plurality of fixing parts, and the fixing parts are arranged in the fixing holes and abut against inner walls of the fixing holes.

14. The massage belt according to claim 1, wherein a rotation axis of the eccentric weight is parallel to the first direction.

15. The massage belt according to claim 8, wherein a distance between an end of the eccentric weight close to the first mounting seat and the first mounting seat is α, and α satisfies: 5 mm ≤ α ≤ 15 mm.

16. The massage belt according to claim 15, wherein the eccentric weight comprises
a main body portion and an extension portion, the main body portion is perpendicular to the first direction, and the extension portion extends in a direction away from the first mounting seat.

17. The massage belt according to claim 1, wherein
the eccentric weight is provided with an insertion hole in an axial direction, the insertion hole is a non-circular hole, an output shaft of the motor comprises an installation section, a shape of the installation section matches a shape of the insertion hole, and the installation section is accommodated in the insertion hole so that the output shaft of the motor is drivingly connected to the eccentric weight.

18. The massage belt according to claim 17, wherein the vibration assembly further comprises
a locking member, the eccentric weight is provided with a threaded hole in a radial direction, the locking member is threadedly connected to the threaded hole, and the locking member passes through the eccentric weight and abuts against the output shaft of the motor.

19. The massage belt according to claim 18, wherein
the output shaft of the motor is provided with a receiving groove in a radial direction, the locking member extends into the receiving groove and abuts against a bottom wall of the receiving groove.

20. The massage belt according to claim 18, wherein
the output shaft of the motor is provided with a receiving hole in a radial direction, the locking member is threadedly connected to the receiving hole and abuts against an inner wall of the insertion hole.
